(19) United States
(12) Patent Application Publication
(10) Pub. No.: US 2009/0234714 A1
(43) Pub. Date: Sep. 17, 2009

(54) SOFTWARE DISTRIBUTION SYSTEM WITH ADVERTISING REVENUE SUBSIDY AND METHOD OF OPERATION THEREOF

(75) Inventors: Lev M. Bolotin, Kirkland, WA (US); Simon B. Johnson, Bonney Lake, WA (US)

Correspondence Address: LAW OFFICES OF MIKIO ISHIMARU, 333 W. EL CAMINO REAL, SUITE 330, SUNNYVALE, CA, 94087, US

(73) Assignee: CLEVX, LLC, Kirkland, WA (US)

(21) Appl. No.: 12/403,315

(22) Filed: Mar. 12, 2009

Related U.S. Application Data
(60) Provisional application No. 61/035,984, filed on Mar. 12, 2008.

(51) Int. Cl. G06Q 30/00; G06Q 10/00; G06F 9/44

(52) U.S. Cl. 705/10; 705/14; 705/30; 717/171

(57) ABSTRACT

A method of operation of a software distribution system includes: providing a compute platform; applying an ad-subsidized application in the compute platform including: providing a software application, joining advertised content to the software application for creating a subsidized software application, and installing from a customized storage device or a global communication system to the compute platform the subsidized software application; providing a display from the compute platform for displaying the ad-subsidized application; and accessing a commercial content through the display while having access to the software application.

### CROSS-REFERENCE TO RELATED APPLICATION

This application claims the benefit of U.S. Provisional Patent Application Ser. No. 61/035,984 filed Mar. 12, 2008, and the subject matter thereof is incorporated herein by reference thereto.

### TECHNICAL FIELD

The present invention relates generally to software distribution, and more particularly to a method and system of generating advertising revenue based on software distribution.

### BACKGROUND ART

Retail, shareware, and freeware channels primarily control software sales and distribution. These methods of distribution are susceptible to abuses such as illegal copying and casual distribution. Such abuses result in loss of revenue to software authors and the companies that produce and sell software. Producers of shareware and freeware have limited success in generating revenue as users seldom pay for products on a voluntary basis.

The retail sale of software programs is identical to other types of retail sales with software programs being sold in stores, through the mail, and more recently, on-line via the Internet. Many software packages, including families of programs, are loaded on new personal computers (PCs) by the original equipment manufacturer (OEM). These software packages may offer a restricted use or a trial subscription to the PC user.

Shareware distribution of software programs is based upon the honor system. Shareware software programs comprise windows that remind the user to register their purchase and pay the fee so that a code may be received by the user and entered in the shareware software program. After the code is entered, the shareware program stops reminding the use to register the software being used.

Freeware software programs are available to the user at no cost and do not solicit any form of payment. Freeware software is the most common type of software downloaded from the Internet. Many freeware software programs are distributed by organizations that also solicit donations to fund their activities. Freeware distribution of software programs collects little or no revenues or the authors of a software program.

All of the previously mentioned software distribution methods are susceptible to being copied and distributed without providing compensation for the authors or distributors of the original software. Many PC users don't acknowledge that such a distribution of licensed material is illegal.

In recent a development, advertising revenue is created by on-line search engines such as Google, Yahoo, and MSN when ads are created based on search topics. Advertisements can also appear in a small window of a home page provided by the previously mentioned search engines. Advertisements are the main mechanism of generating income for Google and others and are a means of delivering the search service to the user for free.

Many people have become accustomed to the concept of network television, in which viewing advertisements is the price for having free access to programming. Programming content with the most viewers commands the highest price for advertising time.

This concept is also applied to magazine and newspaper distribution. Some magazines are distributed free but sell advertising in order to create income. Advertisements are priced according to circulation. In general, the higher the circulation, the higher the price charged for advertisement placement.

A means of creating sponsored software distribution based on advertising revenue is a mechanism to encourage software use (consumption) and distribution, while generating income for software developers. This model mitigates the illegal copying and distribution of programs as people will no longer pay for software applications if they can get it legally for free.

A method for generating advertising revenue based on software distribution requires an Internet connection to a monitoring site for the purpose of gauging the number of times an advertisement has been viewed. In addition, advertisements are required viewing prior to application activation, which may be a source of annoyance to the user.

Thus, a need still remains for a software distribution system with advertising revenue subsidy that can present free or reduced price software applications to PC users while generating a revenue stream for software authors and distributors. In view of the intense growth in the software development and distribution industries, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a software distribution system including: providing a compute platform; applying an ad-subsidized application in the compute platform including: providing a software application, joining advertised content to the software application for creating a subsidized software application, and installing or running from a customized storage device or a global communication system to the compute platform the subsidized software application; providing a display from the compute platform for displaying the ad-subsidized application; and accessing a commercial content through the display while having access to the software application.

The present invention provides a software distribution system including: a compute platform; an ad-subsidized application in the compute platform including: a software application in a first memory, advertised content in a second memory joined to the software application in the first memory for creating a subsidized software application in a third memory, and a customized storage device or a global communication system coupled to the compute platform for executing the subsidized software application; a display from the compute platform for displaying the ad-subsidized application; and a commercial content accessed through the display.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a functional block diagram of a software distribution system with advertising revenue subsidy in an embodiment of the present invention.

FIG. 2 is a bubble chart of the components of the subsidized software application.

FIG. 3 is a functional block diagram of a software distribution system utilizing the global communication system.

FIG. 4 is a functional block diagram of a customized storage device for distribution of the subsidized software application.

FIG. 5 is a functional block diagram of the software distribution system in an update of content process.

FIG. 6 is a process flow diagram for initializing the ad-subsidized application, including updating the commercial content.

FIG. 7 is a block diagram of a display of the ad-subsidized application.

FIG. 8 is a flow chart of a method of operation of a software distribution system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated without regard to orientation.

Where multiple embodiments are disclosed and described, having some features in common, for clarity and ease of illustration, description, and comprehension thereof, similar and like features one to another will ordinarily be described with similar reference numerals. The term “processing” as used herein includes software generation, integration, testing, preparation, packaging, updating and monitoring.

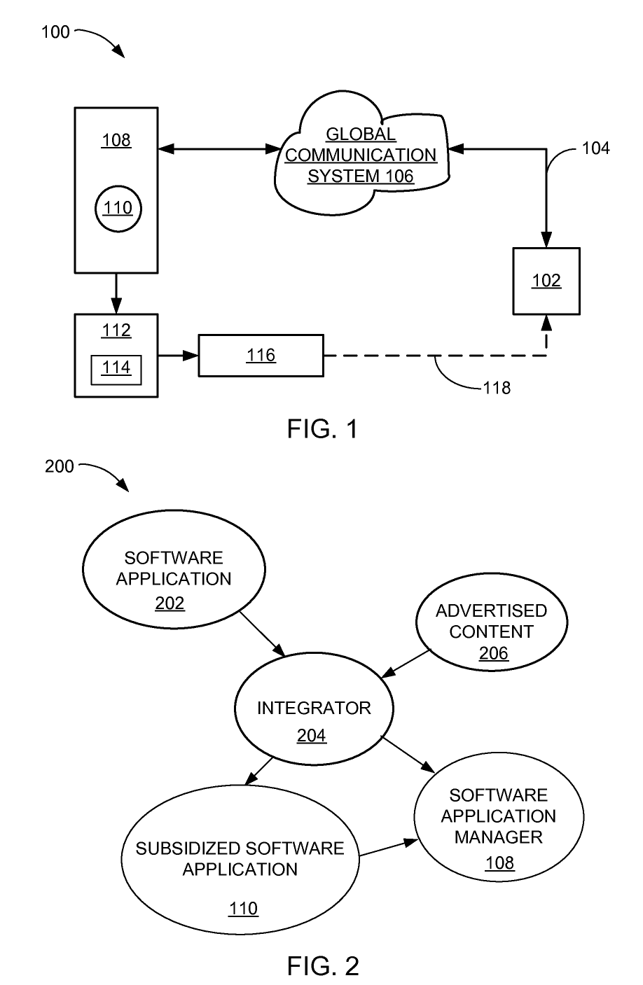

Referring now to FIG. 1, therein is shown a functional block diagram of a software distribution system 100 with advertising revenue subsidy in an embodiment of the present invention. The functional block diagram of the software distribution system 100 depicts a compute platform 102, such as a personal computer (PC), a personal data assistant (PDA), a game platform, a portable telephone, a portable navigation device, or the like, having a connection 104 to a global communication system 106, a mass storage device (not shown) or a compact disk (CD) not shown. The global communication system 106 may include the Internet or global positioning satellite network.

The connection 104, while shown as a solid link, may be any communication link. For example the connection 104 may be a wired connection or a wireless connection, including optical, radio frequency (RF), or cellular means of communication. The global communication system 106, such as the world wide web, may include hardware and software for communicating by transfer control protocol/internet protocol (TCP/IP).

A software application manager 108 may be coupled through the global communication system 106 to the compute platform 102. The software application manager 108 controls all aspects of the processing of a subsidized software application 110, such as an advertising revenue subsidized software application. While the software application manager 108 is shown as a single entity this is an example only and the actual implementation of the software application manager 108 may include a distributed network of systems and facilities.

A subsidized software distributor 112 may package and transport the subsidized software application 110 received from the software application manager 108. The subsidized software distributor 112 may produce a customized storage device 114, such as a game cartridge or a mass storage memory device, which can contain the subsidized software application 110. An advertising cost may be set by the number of the customized storage devices 114 produced.

The subsidized software distributor 112 may submit the customized storage device 114 to a conveyor 116, such as a shipper. The conveyor 116 may move the customized storage device 114 to a location suitable for an end user (not shown) to perform an installation link 118 of the customized storage device 114 to the compute platform 102. The installation link 118 may include receiving the customized storage device 114, such as a postal delivery, pick-up from a distribution outlet, a third party delivery, or the like.

The subsidized software application 110 may be executed on the compute platform 102 by the end user (not shown). The access to the subsidized software application 110 may be through the installation link 118, or downloaded through the connection 104.

Once the subsidized software application 110 is running on the compute platform 102, the operation and maintenance of the subsidized software application 110 is handled by the software application manager 108 or the customized storage device 114. The subsidized software application 110 will communicate with the software application manager 108 or the customized storage device 114 as a normal part of the execution of the subsidized software application 110.

Referring now to FIG. 2, therein is shown a bubble chart of components 200 of the subsidized software application 110. The bubble chart of the components 200 depicts a software application 202, such as a game, a utility program, a service program, or a configuration program, stored in a first memory coupled to an integrator 204. The integrator 204 may be linked to advertised content 206 stored in a second memory, such as promotional material, to be embedded in the software application 202.

The advertised content 206 may enable the end user (not shown) to earn discounts, order products or services, win gifts, locate vendors, or access vendor information. The advertised content 206 may also change with time and a dynamic maintenance process is controlled by the software application manager 108.

The integrator 204 may perform a joining of the software application 202 and the advertised content 206. The joining process may include installing banners, providing an advertising interface, customizing display options, and testing. The integrator 204 provides the subsidized software application 110, in a third memory, for distribution as well as incremental updates for the software application manager 108. When the integrator 204 has completed the joining of the software application 202 and the advertised content 206, it is not possible for the end user (not shown) to separate the software application 202 in a functional condition.

The integrator 204 may join the software application 202 and the advertised content 206 in a way that allows the end user access to the software application 202 while viewing the advertised content 206. The subsidized software application 110 does not require accessing the advertised content 206 in order to make use of the software application 202. Instead the advertised content 206 is presented in a user friendly fashion.

The advertised content 206 may change on a periodic basis and key elements or special offers may be linked to the software application manager 108 by the integrator 204. These changes in the advertised content 206 may be managed dynamically by the software application manager 108.

It has been discovered that the joining of the software application 202 and the advertised content 206 may provide a less intrusive interface to the end user (not shown). It has also been discovered that the dynamic management of the advertised content 206 may create a more interesting environment and enhance the appeal of the target commodity or business.

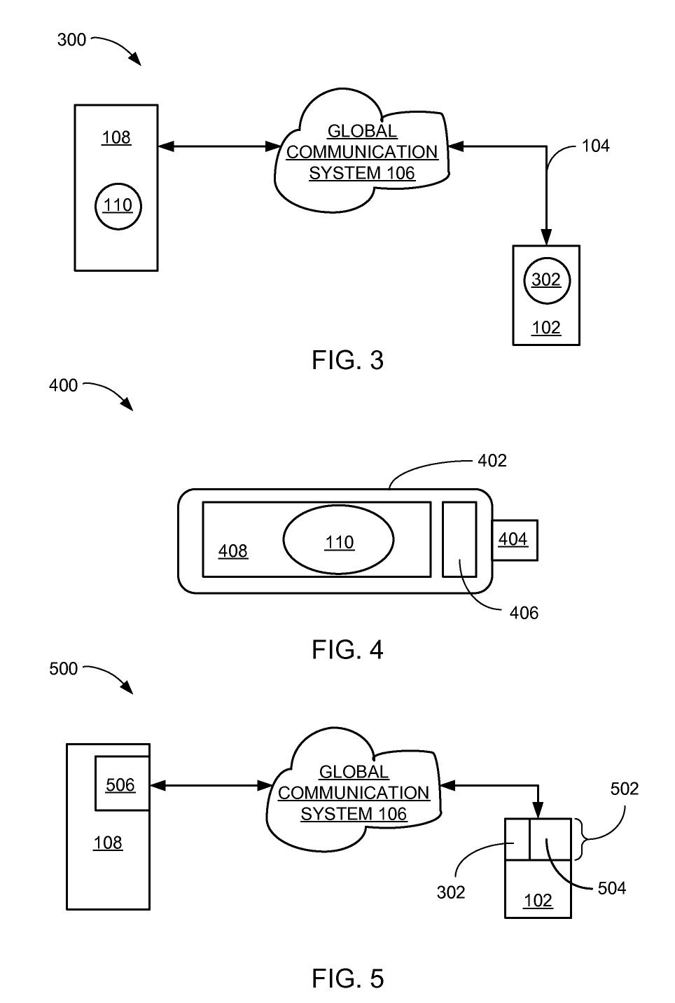

Referring now to FIG. 3, therein is shown a functional block diagram of a software distribution system 300 utilizing the global communication system 106. The functional block diagram of the software distribution system 300 depicts the compute platform 102 having the connection 104 to the global communication system 106.

The connection 104, while shown as a solid link, may be any communication link. For example the connection 104 may be a wired connection or a wireless connection, including optical, RF or cellular means of communication.

The software application manager 108 may be coupled through the global communication system 106 to the compute platform 102. The software application manager 108 controls all aspects of the processing of the subsidized software application 110, such as an advertising revenue subsidized software application. While the software application manager 108 is shown as a single entity this is an example only and the actual implementation of the software application manager 108 may include a distributed network of systems and facilities.

In this embodiment of the present invention, the compute platform 102 would gain access to the subsidized software application 110 by accessing an address on the global communication system 106. By way of an example the compute platform 102 may be a web enabled cell phone, a web enabled game player, or a web enabled PDA downloading the subsidized software application 110 in the form of a game or other entertainment software. An ad-subsidized application 302, such as an advertising subsidized application, may be the result of installing the subsidized software application 110 on the compute platform 102. Installing the subsidized software application 110 on the compute platform 102 may be defined as plugging in the customized storage device 114, downloading the subsidized software application 110 into the memory of the compute platform 102, or a combination thereof.

The compute platform 102 may download the subsidized software application 110 and while executing the ad-subsidized application 302 the end user (not shown) may be appraised of special offers, discounts, products, or services from a sponsoring company. The presentation of the commercial offers is integrated into the operation of the ad-subsidized application 302 in order to enhance the application rather than obstruct it.

All access to the subsidized software application 110 may be performed through the global communication system 106. The software application manager 108 may also monitor responses to the commercial offers presented through the ad-subsidized application 302.

Monitoring the number of installations the software application manager 108 performs allows a means to determine the value, to the sponsor, of the commercial offers embedded and presented by the ad-subsidized application 302. An increased number of the ad-subsidized application 302 would correspondingly increase the amount a vendor could charge the sponsor to present the commercial offers through the ad-subsidized application 302.

Referring now to FIG. 4, therein is shown a functional block diagram of a customized storage device 400 for distribution of the subsidized software application 110. The functional block diagram of the customized storage device 400 depicts a mass storage device 402 having an interface plug 404, interface electronics 406, and memory storage 408. The subsidized software application 110 may reside in the memory storage 408 in a format suitable for installation on the compute platform 102, of FIG. 1.

The customized storage device 400 may actually be a subset of the customized storage device 114 and is a specific example of a possible implementation thereof. In this example the customized storage device 400 takes the shape of a universal serial bus (USB) memory stick. This is only an example and other configurations are likely to be available, such as a compact disk, compact flash memory, secure digital memory, USB disk storage, or other disk storage, having the subsidized software application 110 pre-loaded.

The customized storage device 400 may be sold at a retail outlet, mail ordered, or be given away as a promotional item. The number of installations of the subsidized software application 110 may be used to determine the pricing of the advertised content 206, of FIG. 2.

Referring now to FIG. 5, therein is shown a functional block diagram of the software distribution system 500 in an update of commercial content process. The functional block diagram of the software distribution system 500 depicts the compute platform 102 having system memory 502 which may include the ad-subsidized application 302 and commercial content memory 504 loaded therein.

The configuration of the system memory 502 is an example only and it may include the memory storage 408, of FIG. 4, as well as other memory (not shown) that may reside in the compute platform 102. At pre-determined intervals, such as the beginning or end of execution or other times to be defined by the integrator 204, of FIG. 2, the ad-subsidized application 302 may request an update of the data in the commercial content memory 504 that is to be presented during execution of the ad-subsidized application 302.

In order to refresh the data in the commercial content memory 504, the ad-subsidized application 302 may access a web interface 506 in the software application manager 108 through the global communication system 106 or retrieve the data from the customized storage device 400. If new commercial content is available from the customized storage device 400 it may be directly loaded into the commercial content memory 504. If no updates are available through the customized storage device 400, the ad-subsidized application 302 may interrogate the software application manager 108.

If new commercial content is available, the software application manager 108 will present the commercial content to be transferred to the web interface 506. Any accesses of the data in the commercial content memory 504, by the end user, may be monitored by the software application manager 108 through the global communication system 106 in order to calculate revenue generated.

The new commercial content will be transferred under control of the ad-subsidized application 302. As packets are received across the global communication system 106, the ad-subsidized application 302 will process the packets and store the new commercial content in the commercial content memory 504.

It has been discovered that the dynamic management of the commercial content displayed by the ad-subsidized application 302 allows great flexibility in presenting time critical commercial offers. As an example, a discount may be available on certain products for only a portion of a day. The ad-subsidized application 302 can detect the window of time that the offer is valid and only display the discount option during that time.

It has also been discovered that during the update of commercial content process a redirection to an alternate web site may provide quicker responses during times of heavy internet traffic.

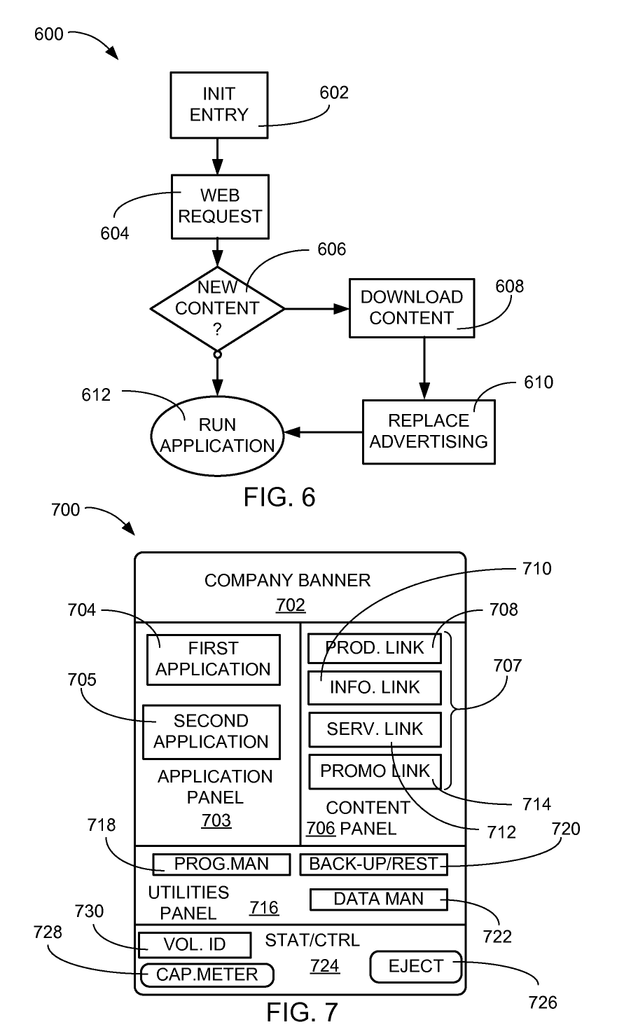

Referring now to FIG. 6, therein is shown a process flow diagram for initializing the ad-subsidized application 302, including updating the commercial content. The process flow diagram for initializing the ad-subsidized application 302 depicts an initialization entry 602, such as an address in the system memory for an entry point in the ad-subsidized application 302 that may be entered at the start of execution of the software application 202, of FIG. 2, or may be a re-entry point for priority or interval reloads of the commercial content. The initialization entry 602 may be located in the memory internal to the compute platform 102 or it may be located within the customized storage device 400.

The initialization entry 602 may be coupled to a web site request 604. The web site request 604 may provide an alternate web address during high traffic activity, it may indicate that no update of the commercial content is available, or it may indicate an update is available.

The web site request 604 may be coupled to a new content decision 606. The new content decision 606 examines the response from the web site request 604 to determine if an update of the commercial content is available. If no update is available the new content decision 606 exits to a run software application 612.

If the new content decision 606 determines that an update is available it exits to a download commercial content 608. The download commercial content 608 manages the transfer of the new commercial content from the designated web site and stores the data in a temporary buffer location then moves to a replace advertising content 610.

The replace advertising content 610 parses the new commercial content to the proper memory locations for integration into the ad-subsidized application 302. The replace advertising content 610 also determines if there is time critical commercial content in the new delivery and sets appropriate timer intervals to initiate re-entry to the initialization entry 602. When the replace advertising content 610 has completed the preparation the run software application 612 is entered.

The updating of the commercial content is executed very quickly and no perceptible delay in the operation of the ad-subsidized application 302 can be detected.

Referring now to FIG. 7, therein is shown a block diagram of a display 700 of the ad-subsidized application 302. The block diagram of the display 700 depicts a company banner 702, such as an area of the display showing the company logo, company name, and company recognition information, as text or graphics. The display 700 of the current invention may be a user interface screen or a linked device that presents a coupon.

An application selection panel 703 may present icons for the selection of applications currently installed, such as a software application icon 704 for executing the software application 202, of FIG. 2. The application selection panel 703 may be updated if additional applications are stored in the customized storage device 400, of FIG. 4, such as an additional application icon 705.

A commercial content panel 706 may display icons that link the commercial content to the display 700. The commercial content panel 706 may include access links to a commercial content 707, such as a products link 708, a company information link 710, a services offered link 712, and a special promotions link 714. It is understood that the links defined for the commercial content panel 706 are an example only and other configurations and links are possible. The definition and number of links presented in the commercial content panel 706 may change at any time.

As an example the product link 708 may provide access to purchase a product or products from a sponsoring company. Also by way of an example the company information link 710, the services offered link 712, and the special promotions link 714 may provide access to information or offers from the sponsoring company.

A utilities support panel 716 may contain a program management link 718, a data back-up and restore link 720, and a data management link 722. It is also understood that these defined links are an example only and other services or utilities are possible.

A status and control banner 724 may include an eject link 726, a capacity meter 728, and a volume ID frame 730. The display 700 as described is an example and other configurations are possible. The background may be customized with the company colors or other identifying signs or text as desired.

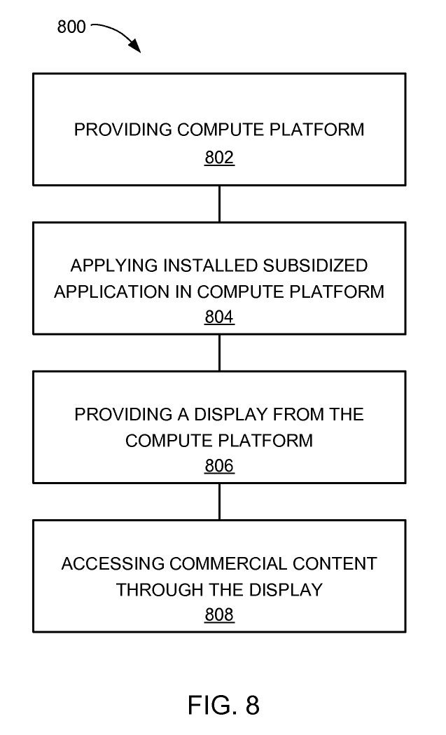

Referring now to FIG. 8, therein is shown a flow chart of a method 800 of operation of a software distribution system in a further embodiment of the present invention. The method 800 includes: providing a compute platform in a block 802; applying an ad-subsidized application in the compute platform including: providing a software application, joining advertised content to the software application for creating a subsidized software application, and installing from a customized storage device or a global communication system to the compute platform the subsidized software application in a block 804; providing a display from the compute platform for displaying the ad-subsidized application in a block 806; and accessing a commercial content through the display while having access to the software application in a block 808.

Thus, it has been discovered that the software distribution system and device or product of the present invention furnishes important and heretofore unknown and unavailable solutions, capabilities, and functional aspects for providing subsidized software applications at low or no cost to the end user.

The resulting method, process, apparatus, device, product, and/or system is straightforward, cost-effective, uncomplicated, highly versatile and effective, can be surprisingly and unobviously implemented by adapting known technologies, and are thus readily suited for efficiently and economically operating software distribution systems fully compatible with conventional manufacturing methods or processes and technologies.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a software distribution system comprising:
providing a compute platform;
applying an ad-subsidized application in the compute platform including:
providing a software application,
joining advertised content to the software application for creating a subsidized software application, and
installing from a customized storage device or a global communication system to the compute platform the subsidized software application;
providing a display from the compute platform for displaying the ad-subsidized application; and
accessing a commercial content through the display while having access to the software application.

2. The method as claimed in claim 1 further comprising updating a commercial content panel, for accessing the commercial content, while initializing the ad-subsidized application on the display.

3. The method as claimed in claim 1 further comprising providing a software application monitor for determining revenue including:
providing a web interface on the software application monitor for counting the subsidized software applications installed; and
monitoring a commercial content memory in the compute platform through the global communication system.

4. The method as claimed in claim 1 further comprising providing an integrator for joining the software application and the advertised content.

5. The method as claimed in claim 1 further comprising accessing an initialization entry when starting the ad-subsidized application or at a pre-determined time.

6. A method of operation of a software distribution system comprising:
providing a compute platform having a system memory;
applying an ad-subsidized application in the compute platform including:
providing a software application,
joining advertised content to the software application for creating a subsidized software application, and
installing from a customized storage device or a global communication system to the compute platform the subsidized software application including loading the system memory;
providing a display from the compute platform for displaying the ad-subsidized application including displaying a company banner and a status and control banner; and
accessing a commercial content through the display while having access to the software application including displaying a product link, a services offered link, or a combination thereof.

7. The method as claimed in claim 6 further comprising updating a commercial content panel, for accessing the commercial content, while initializing the ad-subsidized application on the display by accessing a connection to the global communication system or reading from the customized storage device.

8. The method as claimed in claim 6 further comprising providing a software application monitor for determining revenue including:
providing a web interface on the software application monitor for counting the subsidized software applications installed including downloading the subsidized software application through the web interface; and
monitoring a commercial content memory in the compute platform through the global communication system for counting the number of accesses to the product link, the services offered link, or the combination thereof.

9. The method as claimed in claim 6 further comprising providing an integrator for joining the software application and the advertised content including providing incremental updates to a software application manager.

10. The method as claimed in claim 6 further comprising accessing an initialization entry when starting the ad-subsidized application or at a pre-determined time including setting an appropriate timer interval based on a time critical commercial content.

11. A software distribution system comprising:
a compute platform;
an ad-subsidized application in the compute platform including:
a software application in a first memory,
advertised content in a second memory joined to the software application in the first memory for creating a subsidized software application in a third memory, and
a customized storage device or a global communication system coupled to the compute platform for installing the subsidized software application;
a display from the compute platform for displaying the ad-subsidized application; and
a commercial content accessed through the display.

12. The system as claimed in claim 11 further comprising a commercial content panel, with access to the commercial content, includes the ad-subsidized application initialized on the display.

13. The system as claimed in claim 11 further comprising a software application monitor to determine revenue includes:
a web interface on the software application monitor for counting the subsidized software applications installed; and
a commercial content memory in the compute platform monitored through the global communication system.

14. The system as claimed in claim 11 further comprising an integrator for joining the software application and the advertised content.

15. The system as claimed in claim 11 further comprising an initialization entry in the system memory or the customized storage device to start the ad-subsidized application or reload the commercial content at a pre-determined time.

16. The system as claimed in claim 11 further comprising:
a system memory in the compute platform;
a company banner and a status and control banner on the display of the compute platform; and
a product link, a services offered link, or a combination thereof on the display.

17. The system as claimed in claim 16 further comprising a commercial content panel, with access to the commercial content, includes the ad-subsidized application initialized on the display by a connection to a global communication system or the customized storage device read to update the commercial content panel.

18. The system as claimed in claim 16 further comprising a software application monitor to determine revenue includes:
a web interface on the software application monitor for counting the subsidized software applications installed includes the subsidized software application downloaded through the web interface; and
a commercial content memory in the compute platform monitored through the global communication system includes the product link, the services offered link, or the combination thereof detected.

19. The system as claimed in claim 16 further comprising an integrator for joining the software application in a first memory and the advertised content in a second memory includes a software application manager with incremental updates.

20. The system as claimed in claim 16 further comprising an initialization entry in the system memory or the customized storage device to start the ad-subsidized application or reload the commercial content at a pre-determined time includes an appropriate timer interval set based on a time critical commercial content.
